(19) United States
(12) Patent Application Publication
(10) Pub. No.: US 2012/0310898 A1
(43) Pub. Date: Dec. 6, 2012

(54) SERVER AND METHOD FOR MANAGING MONITORED DATA

(75) Inventors: CHI-CHIH WANG, Tu-Cheng (TW); CHIEN-MING CHANG, Tu-Cheng (TW); DONG SHANG, Shenzhen City (CN); CUN-SHAN LU, Shenzhen City (CN)

(73) Assignees: HON HAI PRECISION INDUSTRY CO., LTD., Tu-Cheng (TW); GDS SOFTWARE (SHENZHEN) CO.,LTD, ShenZhen City (CN)

(21) Appl. No.: 13/463,820

(22) Filed: May 4, 2012

(30) Foreign Application Priority Data
May 31, 2011 (CN) 201110144401.0

(51) Int. Cl. G06F 17/30

(52) U.S. Cl. 707/687; 707/736; 707/E17.032; 707/E17.127

(57) ABSTRACT

A method executed by a processor of a server sets device parameters and system parameters in relation to the server and one or more monitoring devices, and collects data from each of the one or more monitoring devices according to the set device parameters and system parameters. The collected data is stored into a first queue, and read at a specified time interval, and then stored into a database. Any abnormality in the operation of the monitoring devices is stored into a second queue and processed in real-time.

### BACKGROUND

1. Technical Field

Embodiments of the present disclosure generally relate to data management technology, and more particularly to a server and a method for managing monitored data.

2. Description of Related Art

Management of data from monitoring activities, for example, collecting and storing the data from monitoring, is very important for real-time monitoring. If there is a large number of monitoring devices producing the data, the management of the monitoring devices is complicated and difficult.

### BRIEF DESCRIPTION OF THE DRAWINGS

FIG. 1 is a block diagram of one embodiment of a monitoring server including a management unit for managing monitored data.

FIG. 2 is a block diagram of one embodiment of function modules of the management unit.

FIG. 3 is a flowchart of one embodiment of a method for managing monitored data.

### DETAILED DESCRIPTION

The application is illustrated by way of examples and not by way of limitation in the figures of the accompanying drawings in which like references indicate similar elements. It should be noted that references to “an” or “one” embodiment in this disclosure are not necessarily to the same embodiment, and such references mean at least one.

In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

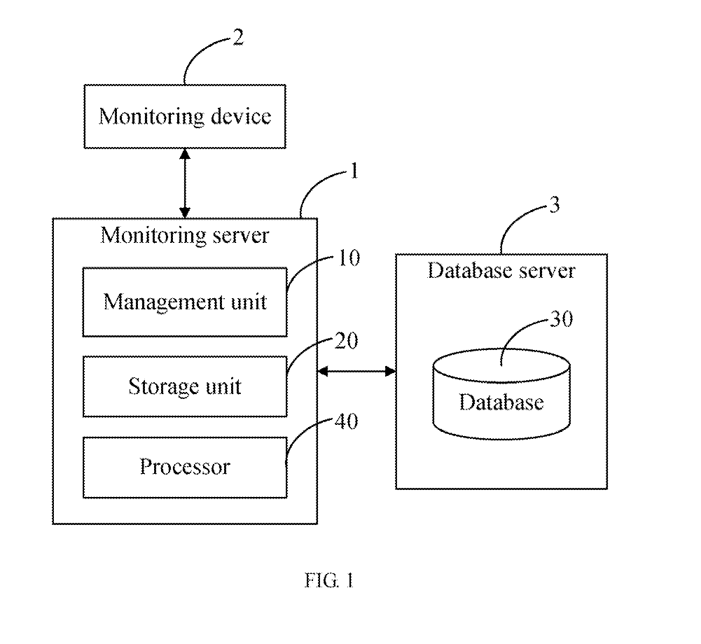

FIG. 1 is a block diagram of one embodiment of a monitoring server 1 including a management unit 10 for managing monitored data. The monitoring server 1 further includes a storage unit 20 and a processor 40, and electrically connects to one or more monitoring devices 2 (only one is shown in FIG. 1) and a database server 3.

In the embodiment, the monitoring device 2, for example, a camera, a sound monitor, or an alarm detector, monitors nearby objects and sends data in relation to the objects (“monitored data”) to the monitoring server 1. The database server 3 is a server which includes a database 30, used to store the monitored data. The monitoring server 1 collects monitored data from the monitoring devices 2 and stores the monitored data into the database 30. It is understood that in other embodiments, the monitoring server 1 and the database server 3 can be integrated as one server. The monitored data may include images, video, audio, or a combination thereof.

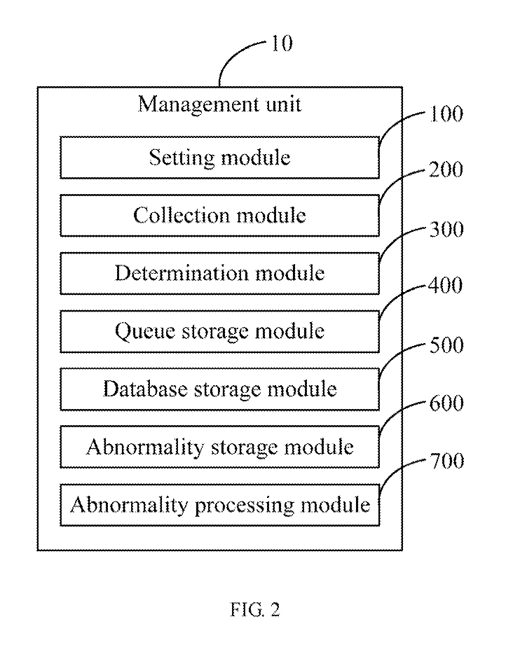

In one embodiment, the management unit 10 may include one or more function modules (a description is given in FIG. 2). The one or more function modules may comprise computerized code in the form of one or more programs that are stored in the storage unit 20, and executed by the processor 40 to provide the functions of the management unit 10. The storage unit 20 may be a cache or a dedicated memory, such as an erasable programmable read only memory (EPROM) or a flash memory.

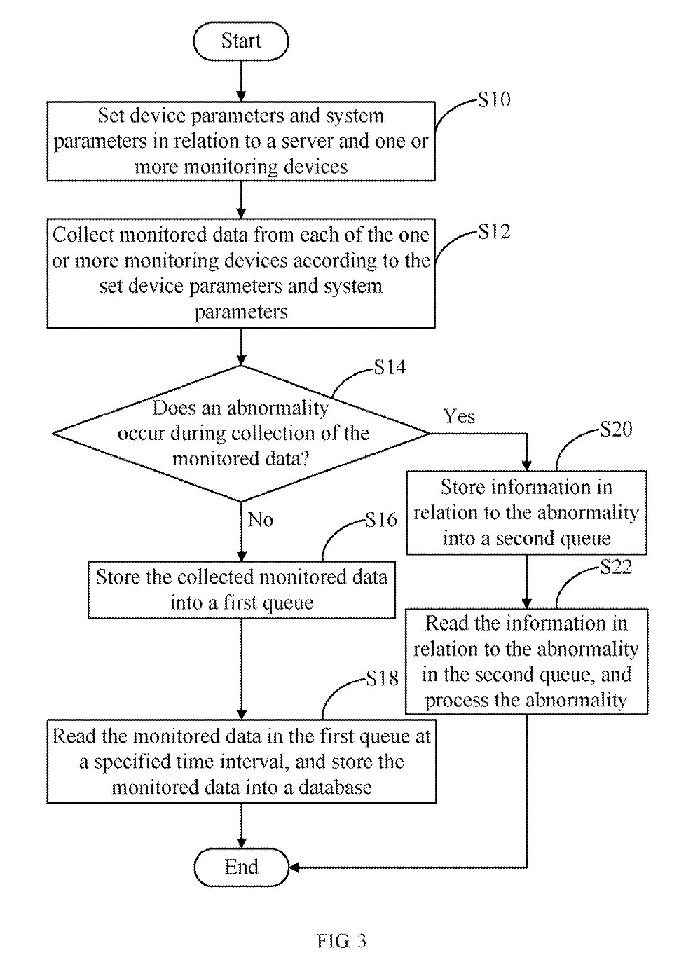

FIG. 2 is a block diagram of one embodiment of the function modules of the management unit 10. In one embodiment, the management unit 10 includes a setting module 100, a collection module 200, a determination module 300, a queue storage module 400, a database storage module 500, an abnormality storage module 600, and an abnormality processing module 700. A detailed description of the functions of the modules 100-700 is given in FIG. 3.

FIG. 3 is a flowchart of one embodiment of a method for managing monitored data. Depending on the embodiment, additional steps may be added, others removed, and the ordering of the steps may be changed.

In step S10, the setting module 100 sets device parameters and system parameters in relation to the one or more monitoring devices 2 and the monitoring server 1. The device parameters, for example, include types of monitored data submitted by the monitoring devices 2, are parameters used to manage the monitoring device 2 or data submitted by the monitoring device 2. The system parameters, for example, include a collection frequency of the monitored data, are parameters used to manage the monitoring server 1, and more particularly to manage the data collection procedure of the monitoring server 1. In one embodiment, the device parameters and system parameters are recorded in documents in XML format. The setting means that the setting module 100 reads the XML documents to obtain the device parameters and system parameters. In such a manner, the user can flexibly change the device parameters and system parameters in the XML documents.

In step S12, the collection module 200 collects monitored data from each of the one or more monitoring devices 2 according to the set device parameters and system parameters. For example, the collection module 200 receives the monitored data with the collection frequency from the monitoring device 2.

In one embodiment, the collected monitored data includes real-time data and historical data. The real-time data is monitored data currently being collected, and the collection frequency of the real-time data can be high, such as every 30 seconds. The historical data is monitored data collected at a first specified time interval, for example, 15 minutes. The quantity of the real-time data is usually very large, so users usually just need a proportion of the real-time data, and most of the time will use the historical data.

In step S14, the determination module 300 determines whether an abnormality occurs during collection of the monitored data. In the embodiment, the abnormality may include the monitoring device 2 cannot be connected, or the monitoring device 2 sends data in a wrong format, for example. If there no abnormality during the collection of the monitored data, step S16 is implemented. If any abnormality occurs during collection of the monitored data, step S20 is implemented.

In step S16, the queue storage module 400 stores the collected monitored data into a first queue. The first queue is a queue created and stored in the storage unit 20.

In other embodiments, the queue storage module 400 may store the collected monitored data into a XML document, and then remove the monitored data in the XML document to the first queue at a second specified time interval.

In step S18, the database storage module 500 reads the monitored data in the first queue at a third specified time interval, and stores the monitored data into the database 30. In the embodiment, the database storage module 500 stores the historical data into a historical data list, and stores the real-time data into a real-time data list. The historical data list and the real-time data list are data lists created in the database 30. In other embodiments, the database storage module 500 may not store the real-time data, and just stores the historical data.

In step S20, the abnormality storage module 600 stores information in relation to the abnormality into a second queue. The second queue is a queue created in the storage unit 20. The information of the abnormality may include a device type and a device number of the monitoring device 2 which is operating abnormally, and an abnormality code. The abnormality code is sent by the monitoring device 2 which is operating abnormally. If any abnormality occurs during collection of the monitored data, for example, the monitoring device 2 cannot be connected, or the monitoring device 2 sends data in a wrong format, the monitoring device 2 is operating abnormally. Otherwise, the monitoring device 2 is operating normally.

In step S22, the abnormality processing module 700 reads the information in relation to the abnormality in the second queue, and processes the abnormality. For example, the abnormality processing module 700 may adjust the device parameters, or stop collecting the monitored data, or mark the monitoring device 2 which has the abnormality as unusable, and stores data relating to the processing to a daily record.

In the embodiment, the step S10, the steps S12-16, the step S18, and the steps S20-22 are independently implemented by multi-thread processing. The multi-thread processing shares and transfers data through the first queue or XML documents. The method can be used to manage the monitored data sent by more than one monitoring device 2, and can be repeatedly used in multi-monitoring procedures.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A method for managing monitored data being executed by a processor of a server, the method comprising:
(a) setting device parameters and system parameters in relation to the server and one or more monitoring devices connected to the server;
(b) collecting monitored data from each of the one or more monitoring devices according to the set device parameters and system parameters;
(c) storing the collected monitored data into a first queue; and
(d) reading the monitored data in the first queue at a specified time interval, and storing the monitored data into a database.

2. The method as claimed in claim 1, wherein between the step (b) and the step (c) the method further comprising:
(e) determining whether an abnormality occurs during collection of the monitored data, and implementing the step (c) in response that no abnormality occurs; and
(f) storing information in relation to the abnormality into a second queue in response that the abnormality occurs during collection of the monitored data.

3. The method as claimed in claim 2, wherein the step (a), the steps (b-c), the step (d), and the step (f) are independently implemented by multi-thread processing.

4. The method as claimed in claim 1, wherein in the step (a), the device parameters and system parameters are obtained from documents in XML format.

5. A non-transitory storage medium storing a set of instructions, the set of instructions capable of being executed by a processor of a server to perform a method for managing monitored data, the method comprising:
(a) setting device parameters and system parameters in relation to the server and one or more monitoring devices connected to the server;
(b) collecting monitored data from each of the one or more monitoring devices according to the set device parameters and system parameters;
(c) storing the collected monitored data into a first queue; and
(d) reading the monitored data in the first queue at a specified time interval, and storing the monitored data into a database.

6. The non-transitory storage medium as claimed in claim 5, wherein between the step (b) and the step (c) the method further comprising:
(e) determining whether an abnormality occurs during collection of the monitored data, and implementing the step (c) in response that no abnormality occurs; and
(f) storing information in relation to the abnormality into a second queue in response that the abnormality occurs during collection of the monitored data.

7. The non-transitory storage medium as claimed in claim 6, wherein the step (a), the steps (b-c), the step (d), and the step (f) are independently implemented by multi-thread processing.

8. The non-transitory storage medium as claimed in claim 5, wherein in the step (a), the device parameters and system parameters are obtained from documents in XML format.

9. A server, the server being connected to one or more monitoring devices and a database server, the server comprising:
a storage unit;
at least one processor; and
one or more programs stored in the storage unit, executable by the at least one processor, the one or more programs comprising:
a setting module operable to set device parameters and system parameters in relation to the server and the one or more monitoring devices;
a collection module operable to collect monitored data from each of the one or more monitoring devices according to the set device parameters and system parameters;
a queue storage module operable to store the collected monitored data into a first queue; and
a database storage module operable to read the monitored data in the first queue at a specified time interval, and store the monitored data into a database in the database server.

10. The server as claimed in claim 9, wherein the one or more programs further comprising:
a determination module operable to determine whether an abnormality occurs during collection of the monitored data, and detonate the queue storage module to store the collected monitored data into the first queue in response that no abnormality occurs; and
an abnormality storage module operable to store information in relation to the abnormality into a second queue in response that the abnormality occurs during collection of the monitored data.

11. The server as claimed in claim 10, wherein the setting module, the collection module and queue storage module, the database storage module, and the abnormality storage module are independently applied by multi-thread processing.

12. The server as claimed in claim 9, wherein the device parameters and system parameters are obtained from documents in XML format.
